(19) United States
(12) Patent Application Publication
(10) Pub. No.: US 2018/0025621 A1
(43) Pub. Date: Jan. 25, 2018

(54) FAST RESPONDING CAMERA SURVEILLANCE SYSTEM WITH LOW POWER CONSUMPTION AND LOW FALSE ALARM RATE

(71) Applicant: BRICKCOM CORPORATION, Hsinchu Hsien (TW)

(72) Inventors: YUNG-HSIANG HUANG, HSINCHU HSIEN (TW); KUN-CHENG HUANG, HSINCHU HSIEN (TW)

(21) Appl. No.: 15/277,165

(22) Filed: Sep. 27, 2016

(30) Foreign Application Priority Data
Jul. 25, 2016 (TW) 105123418

(51) Int. Cl. G08B 29/18; G06K 9/00; G08B 13/196; H04N 5/232

(52) U.S. Cl. CPC G08B 29/185; H04N 5/23241; G06K 9/00771; G08B 13/19656; G08B 13/1966; G08B 13/19617; G08B 13/19613

(57) ABSTRACT

A fast responding surveillance system with low power consumption and a low false alarm rate is provided. An alarm is issued through a button or a sensor to request a microcontroller to activate an image capturing module to capture at least one alarm image, and a first low-power RF module is activated to transmit the alarm image to an intelligent analysis module for analysis to generate a determination result. When the determination result indicates a false alarm, the alarm image is discarded, and the first low-power RF module and the image capturing module are turned off. When the determination result indicates a valid alarm, the image capturing module captures a high-quality video, a first video transmission module is activated to transmit the high-quality video, and the first low-power RF module is turned off.

### FIELD OF THE INVENTION

The present invention relates to a camera surveillance system, and particularly to a fast responding camera surveillance system with low power consumption and a low false alarm rate.

### BACKGROUND OF THE INVENTION

Surveillance cameras are often installed at doors, entrances and exits, and doorways. Conventionally, to install a surveillance camera, wiring needs to deployed to provide power and transmit image data. However, such wiring leaves inevitable external lines that can only be covered using decorative designs to reduce visual conflicts. With the advancement of wireless broadband technologies, applications transmitting image data through wireless technologies (e.g., WiFi) have become common, in a way that wiring complications can be eliminated. Thus, for particular installation environments, such as spaces outside a household, e.g., an exterior space from a door entrance, a balcony, a rooftop space and outdoors, or for a mobile surveillance camera, image data and control signals are usually transmitted wirelessly. However, if a surveillance camera is at the same time powered by batteries, with the limited battery capacity, how to prolong the utilization time of a surveillance camera is a much attended task.

Although providing good data transmission bandwidth and transmission distance, a wireless broadband transmission system may have a slower speed in transmitting alarm information as it requires a longer connection time. However, if a wireless broadband transmission interface is constantly caused to be in a connected state over an extended period of time, the power consumption becomes a huge burden on the battery of the surveillance camera.

The U.S. Pat. Nos. 7,609,952 B1, 7,928,842 B2 and 8,193,933 B2, “Apparatus and Method for Remote Viewing System”, are a patent family disclosing a surveillance system that employs radio-frequency (RF) as an activation signal. The surveillance system transmits the activation signal by RF to a surveillance camera, which immediately turns on the camera upon receiving the activation signal. Further, the surveillance camera includes a timer element. When the timer element does not receive the activation signal for a predetermined period, the camera is turned off to save power consumption. Under the above architecture, by providing minimal power to the surveillance camera, the RF receiving circuit is maintained in a turned-on state to receive the activation signal, hence saving a significant amount of power consumption.

The above disclosures are applicable to animal surveillance as well as elderly and baby household care. However, the RF mechanism is used only to activate the surveillance camera from a remote end. Further, limited by the bandwidth of RF, the photographing element involved is preferably a micro photographing element with low power consumption and providing black and white images, or even only a low-resolution camera incapable of providing high-resolution images can be used. Further, the above disclosures lack intelligent determination processes for verifying the validity of alarms, in a way that not only the user end may frequently receive notifications of false alarms and be disturbed, but also bandwidth and power resources are wasted. It is apparent that the above disclosures are unsuitable for security systems.

### SUMMARY OF THE INVENTION

Therefore, it is a primary object of the present invention to provide a fast responding surveillance camera system with lower power consumption and a lower false alarm rate suitable for a security system.

To achieve the above objet, a surveillance camera system of the present invention includes a battery power surveillance camera and a central control system wireless connected to the battery powered surveillance camera. The battery powered surveillance camera includes a first low-power radio-frequency (RF) module that is normally turned off, an image capturing module that is normally turned off, a first video transmission module that is normally turned off, a microcontroller and a first operation processor. The central control system includes an intelligent analysis module, a second low-power RF module, a second video transmission module and a second operation processor.

When the microcontroller is woken up by a wakeup signal, the first low-power RF module and the image capturing module are activated, so as to capture at least one alarm image through the image capturing module and transmit the alarm image through the first low-power RF module to the second low-power RF module. Thus, the central control system is allowed to obtain the alarm image. The second operation processor forwards the alarm image to the intelligent analysis module for analysis to generate a determination result. The determination result is one selected from a false alarm and a valid alarm. When the determination result indicates the false alarm, the second operation processor discards the alarm image, and notifies the microcontroller to turn off the first low-power RF module and the image capturing module. When the determination result indicates the valid alarm, the second operation processor notifies the microcontroller to instruct the image capturing module to capture a high-quality video, turn on the first video transmission module and turn off the first low-power RF module. The high-quality video is transmitted to the central control system through the first video transmission module and the second video transmission module.

Accordingly, in the present invention, by using the low power consumption and fast transceiving capability characteristics of the first low-power RF module, the alarm image is first captured, and the intelligent analysis module is then caused to determine whether to activate the more power-consuming first video transmission module. Thus, power consumption is saved and the response speed is increased. Meanwhile, false alarms are significantly reduced to increase user satisfaction, and the network transmission amount caused by false alarms are greatly lowered to satisfy application requirements.

### BRIEF DESCRIPTION OF THE DRAWINGS

FIG. 1 is a system structural diagram of the present invention;

FIG. 2 is a circuit schematic diagram of the present invention; and

FIG. 3 is a system flowchart of the present invention.

### DETAILED DESCRIPTION OF THE PREFERRED EMBODIMENTS

Details and technical features of the present invention are given in embodiments below with reference to the accompanying drawings. It should be noted that, the embodiments are for illustration purposes and are not to be construed as limitations to the present invention.

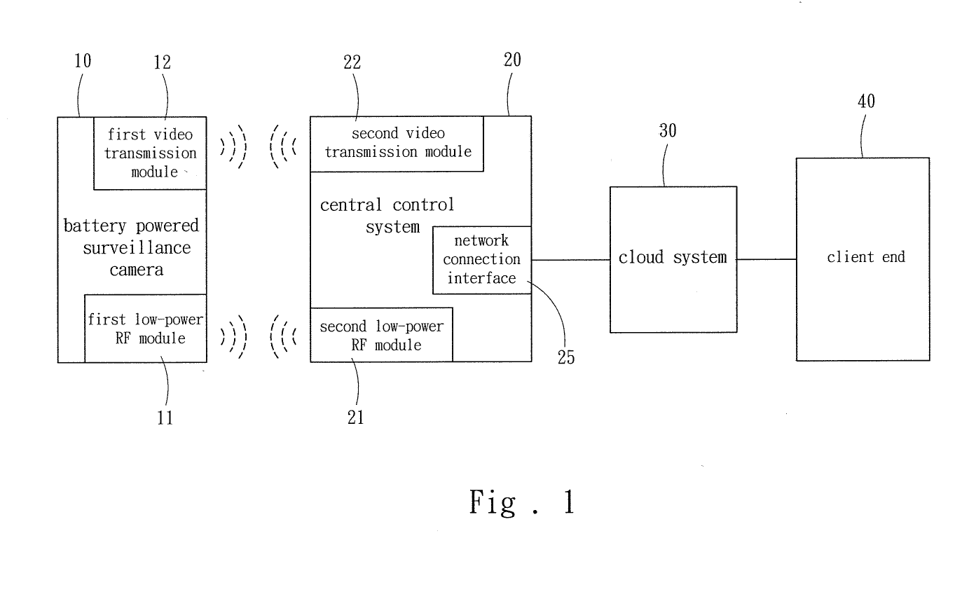

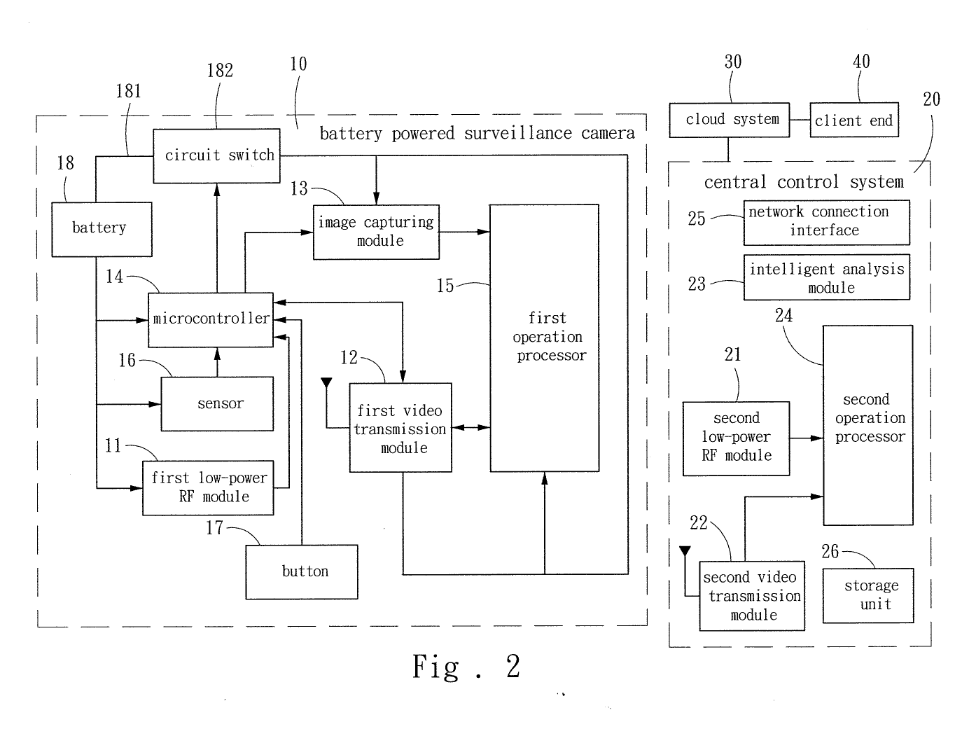

Referring to FIG. 1 and FIG. 2, the present invention provides a fast responding surveillance camera system with low power consumption and a low false alarm rate. The surveillance camera system includes a battery powered surveillance camera 10 and a central control system 20. The battery powered surveillance camera 10 includes a first low-power radio-frequency (RF) module 11 that is normally turned off, a first video transmission module 12 that is normally turned off, an image capturing module 13 that is normally turned off, a microcontroller 14, a first operation processor 15, a sensor 16, a button 17 and a battery 18. The first low-power RF module 11 adopts the low-power RF technology (with an operating frequency lower than 1 GHz), and features fast signal transceiving and low power consumption.

The central control system 20 is wirelessly connected to the battery powered surveillance camera 10, and includes a second low-power RF module 21, a second video transmission module 22, an intelligent analysis module 23, a second operation processor 24, a network connection interface 25 and a storage unit 26. Further, the central control system 20 is connected to a cloud system 30 through the network connection interface 25. The cloud system 30 is connectable to a client end 40. The battery 18 powers the elements, and includes a power loop 181 connected to these elements. A circuit switch 182 is disposed at the power loop 181, and is caused to open to save power when needed. The first video transmission module 12 and the second video transmission module 22 may adopt WiFi, or other wireless transmission technologies with high traffic transmission capability, e.g., 3G, 4G, WiMax, LTE and Bluetooth. Further, the second low-power RF module 21 also adopts the low-power RF technology.

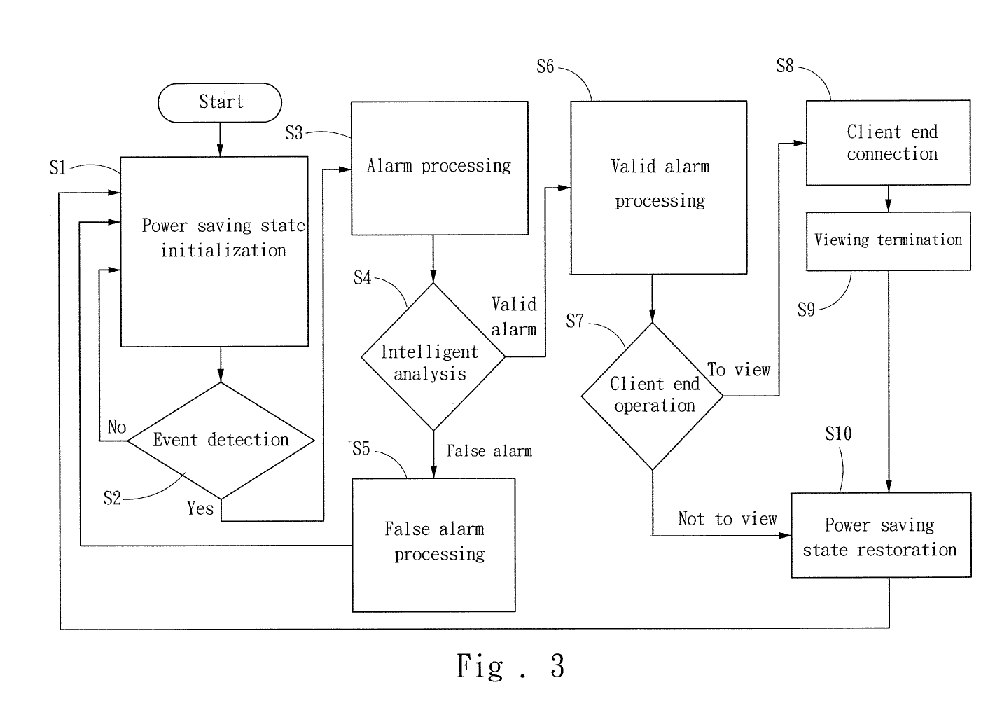

Referring to FIG. 3, processes of the present invention include S1 of power saving state initialization, S2 of event detection, S3 of alarm processing, S4 of intelligent analysis, S5 of false alarm processing, S6 of valid alarm processing, S7 of client end operation, S8 of client end connection, S9 of viewing termination, and S10 of power saving state restoration.

In process S1 of power saving state initialization, in order to have the first low-power RF module 11, the first video transmission module 12 and the image capturing module 13 be in a normally turned-off state for power saving, only the sensor 16 among the active elements is in an activated state and generates a wakeup signal when triggered, and the button 17, as an active element, similarly generates the wakeup signal when pressed.

In process S2 of event detection, when the sensor 16 senses a person, and animal or other objects entering a sensing region, the sensor 16 is activated to generate the wakeup signal. Alternatively, when one presses the button 17, the wakeup signal is similarly generated. Otherwise, process S1 is iterated.

In process S3 of alarm processing, when the microcontroller 14 is woken up by the wakeup signal, the first low-power RF module 11 and the image capturing module 13 are activated, so as to capture at least one alarm image through the image capturing module 13 and transmit the alarm image to the second low-power RF module 21 through the first low-power RF module 11 to have the central control system 20 obtain the alarm image.

In process S4 of intelligent analysis, the second operation processor 24 forwards the alarm image to the intelligent analysis module 23 for analysis to generate a determination result, which is one selected from a false alarm and a valid alarm, and process S5 or S6 is performed according to the determination result. The intelligent analysis module 23 performs analysis according to an image processing technology to obtain an outline of the captured image. For example, when the obtained outline indicates an image of an animal such as a cat or a dog, a false alarm is determined; when the obtained outline indicates an image of a person, a valid alarm is determined. Further, the intelligent analysis may determine whether hazardous factors are present according to an image processing technology, e.g., determining whether the captured image contains a fire source or accumulated water, or even comparing whether the image of a person is a predetermined target.

In process S5 of false alarm processing, when the determination result indicates a false alarm, the second operation processor 24 discards the alarm image and notifies the microcontroller 14 to turn off the first low-power RF module 11 and the image capturing module 13. Process S1 is then iterated.

In process S6 of valid alarm processing, the second operation processor 24 notifies the microcontroller 14 to instruct the image capturing module 13 to capture a high-quality video, turn on the first video transmission module 12 and turn off the first low-power RF module 11, so as to transmit the high-quality video to the central control system 20 via the first video transmission module 12 and the second video transmission module 22.

In process S7 of client end operation, when the determination result indicates a valid alarm, the second operation processor 24 transmits the determination result and the alarm image to the client end 40 via the cloud system 30, and the client end 40 determines whether to view the high-quality video to further perform process S8 or S10.

In process S8 of client end connection, when the client end 40 determines to view the high-quality video, the high-quality video is transmitted to the client end 40 through the network connection interface 25 via the cloud system 30, and the client end 40 is allowed to view the high-quality video till process S9 of viewing termination is performed. Further, the client end 40 may view the high-quality video from a remote end using an application or a computer program on a human-machine interface such as a cell phone, a tablet computer or a computer.

In process S10 of power saving state restoration, when the client end 40 determines not to view the high-quality video in process S7, or process S10 is performed when the client end 40 terminates viewing in process S9, the second operation processor 24 notifies the microcontroller 14 to turn off the image capturing module 13 and the first video transmission module 12, and process S1 is iterated.

In conclusion, the present invention provides following advantages as opposed to the prior art.

1. With the low power and fast transceiving capability characteristics of the first low-power RF module, power consumption can be reduced while the response speed is increased, hence immediately obtaining the alarm image. Thus, the present invention may suitably serve as a security system.

2. By determining whether to activate the more power consuming first video transmission module using the intelligent analysis module, utilization time in which battery power is wasted can be eliminated.

3. It is determined whether a false alarm occurs using smart analysis. When a false alarm occurs, the false alarm is discarded to not only significantly reduce the number of false alarms and increase application satisfaction, but also the network transmission amount caused by false alarms can be prevented at the same time.

What is claimed is:

1. A fast responding surveillance system with low power consumption and a low false alarm rate, comprising:
a batter powered surveillance camera, comprising a first low-power radio-frequency (RF) module that is normally turned off, an image capturing module that is normally turned off, a first video transmission module that is normally turned off, a microcontroller, and a first operation processor; and
a central control system, wirelessly connected to the battery powered surveillance camera, comprising an intelligent analysis module, a second low-power RF module, a second video transmission module and a second operation processor;
wherein, when the microcontroller is woken up by a wakeup signal, the first low-power RF module and the image capturing module are activated to capture at least one alarm image through the image capturing module and transmit the alarm image to the second low-power RF module through the first low-power RF module to have the central control system obtain the alarm image, and the second operation processor forwards the alarm image to the intelligent analysis module for analysis to generate a determination result, which is one selected from a false alarm and a valid alarm; when the determination result indicates the false alarm, the second operation processor discards the alarm image and notifies the microcontroller to turn off the first low-power RF module and the image capturing module; when the determination result indicates the valid alarm, the second operation processor notifies the microcontroller to instruct the image capturing module to capture a high-quality video, turn on the first video transmission module and turn off the first low-power RF module, so as to transmit the high-quality video to the central control system via the first video transmission module and the second video transmission module.

2. The fast responding surveillance system with low power consumption and a low false alarm rate of claim 1, wherein the central controls system further comprises a network connection interface connectable to a client end, and when the determination result indicates the valid alarm, the second operation processor transmits the determination result and the alarm image to the client end and the client end determines whether to view the high-quality video.

3. The fast responding surveillance system with low power consumption and a low false alarm rate of claim 2, wherein when the client end determines not to view the high-quality video, the second operation processor notifies the microcontroller to turn off the image capturing module and the first video transmission module; when the client end determines to view the high-quality video, the high-quality video is transmitted to the client end through the network connection interface; when the client end terminates viewing the high-quality video, the second operation processor notifies the microcontroller to turn off the image capturing module and the first video transmission module.

4. The fast responding surveillance system with low power consumption and a low false alarm rate of claim 1, wherein the central control system is connected to a cloud system through the network connection interface.

5. The fast responding surveillance system with low power consumption and a low false alarm rate of claim 1, further comprising a sensor that generates the wakeup signal when triggered.

6. The fast responding surveillance system with low power consumption and a low false alarm rate of claim 1, further comprising a button that generates the wakeup signal.

7. The fast responding surveillance system with low power consumption and a low false alarm rate of claim 1, wherein the battery powered surveillance camera comprises a battery that powers elements, and the battery comprises a power loop connected to the elements.

8. The fast responding surveillance system with low power consumption and a low false alarm rate of claim 7, wherein a circuit switch is disposed at the power loop.

9. The fast responding surveillance system with low power consumption and a low false alarm rate of claim 1, wherein the first video transmission module and the second video transmission module are one selected from WiFi, 3G, 4G, WiMax, LTE and Bluetooth.
